(19) United States
(12) Patent Application Publication
(10) Pub. No.: US 2019/0225141 A1
(43) Pub. Date: Jul. 25, 2019

(54) HOOD LATCH REPLACEMENT THAT INCLUDES TURN SIGNAL FUNCTIONALITY

(71) Applicants: Chase Max DeLong, Denver, CO (US); Joshua Richolson, Apo, AE (US)

(72) Inventors: Chase Max DeLong, Denver, CO (US); Joshua Richolson, Apo, AE (US)

(21) Appl. No.: 16/214,629

(22) Filed: Dec. 10, 2018

Related U.S. Application Data
(60) Provisional application No. 62/619,200, filed on Jan. 19, 2018.

(51) Int. Cl. B60Q 1/34; E05B 83/24

(52) U.S. Cl. CPC B60Q 1/34; E05B 83/243

(57) ABSTRACT

A replacement hood latching mechanism for components with no turn signal functionality or noncompliant turn signal functionality, enabling such retrofitted vehicles to be compliant. The present invention includes a mechanically movable latch portion providing a visual output device that can be electrically connected to the pre-existing turn signal of the vehicle, thereby providing a more exterior (turn signal functionality along the vehicle if the vehicle originally provided a more interior positioned pre-existing turn signal. Combining the movable latch portion with the pre-existing latch components further enhances the utility and aesthetics of the present invention.

### CROSS-REFERENCE TO RELATED APPLICATION

This application claims the benefit of priority of U.S. provisional application No. 62/619,200, filed 19 Jan. 2018, the contents of which are herein incorporated by reference.

### BACKGROUND OF THE INVENTION

The present invention relates to vehicular accessories and, more particularly, a hood latch mechanism providing a movable latch portion having an output device electrically associated with pre-existing turn signals of the vehicle.

Some vehicles, such as a Jeep™, have a robust aftermarket offering many of alternative or replacement components. Fenders are a very popular aftermarket component. Some of these aftermarket fenders, however, provide a turn signal location which may make the vehicle not street legal in some states, or otherwise make the vehicle non-compliant with some Department of Transportation (DOT) requirements. Typically in these cases, the turn signal functionality is not sufficiently spaced apart from the vehicular body.

As a result, some people choose not to buy those specific aftermarket components, even though they may be very aesthetically pleasing. For those who purchased such aftermarket component only to subsequently learn of their turn-signal deficiencies, current solutions include the costly purchase of another version of the after-market vehicle component that provide additional turn signal functionality to meet DOT requirements, typically along a more exterior portion of the vehicle. Alternatively, more cost-effective solutions may include adding a small light to the vehicle, but these small lights do not blink, flash or otherwise do not provide turn signal functionality, and do not look aesthetically pleasing.

As can be seen, there is a need for a cost-effective solution to the problem of vehicles having DOT noncompliant turn signal location. The present invention provides a solution that is both cost effective and aesthetically pleasing by providing a movable latch portion that mechanically associates with the pre-existing latching mechanism, wherein the movable latch portion includes an output device electrically associated with the pre-existing turn signals of the vehicle.

### SUMMARY OF THE INVENTION

In one aspect of the present invention, a method of providing turn signal functionality spaced apart from a vehicle include the steps of: providing a vehicle with a body and an adjacent hood; pivotably connecting a movable latch portion to the body so that the movable portion moves between an open condition and a closed condition locking the hood to the body; the movable portion providing a turn signal output device; and electrically connecting the turn signal output device to turn signal control circuitry of the vehicle.

In another aspect of the present invention, the method of providing turn signal functionality spaced apart from a vehicle includes the steps of: providing a vehicle with a body and an adjacent hood; pivotably connecting a movable latch portion to the hood so that the movable portion moves between an open condition and a closed condition locking the hood to the body; the movable portion providing a turn signal output device; and electrically connecting the turn signal output device to turn signal control circuitry of the vehicle, as well as in certain embodiments, doing the following: previously connecting a hood latch portion to the hood; previously connecting a body latch portion to the body; the movable latch portion is pivotably connected to the hood latch portion, wherein the hood provides a pre-existing hood latch portion connected to the hood, and wherein the body provides a pre-existing body latch portion connected to the body; and the movable latch portion is pivotably connected to the hood latch portion, wherein the turn signal output device is encased in a case, and wherein the turn signal output device spaced apart sufficiently in the closed condition to meet requirements of relevant state vehicular laws and rules regarding the location of turn signals.

These and other features, aspects and advantages of the present invention will become better understood with reference to the following drawings, description and claims.

### BRIEF DESCRIPTION OF THE DRAWINGS

FIG. 1 is a front perspective detail view of an exemplary embodiment of the present invention, shown in use;

FIG. 2 is a front perspective detail view of an exemplary embodiment of the present invention, demonstrating an operative effect of an output device;

FIG. 3 is a perspective view of an exemplary embodiment of the present invention,

FIG. 4 is a front detail schematic view of an exemplary embodiment of the present invention, shown in use; and

FIG. 5 is a front perspective detail view of an exemplary embodiment of the present invention, demonstrating moving a movable portion of a latch mechanism from a closed condition to an open condition.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a replacement hood latching mechanism for components with no turn signal functionality or DOT noncompliant turn signal functionality, enabling such retrofitted vehicles to be DOT compliant. The present invention includes a mechanically movable latch portion providing a visual output device that can be electrically connected to the pre-existing turn signal of the vehicle, thereby providing a more exterior (and thus DOT-approvable) turn signal functionality along the vehicle (if the vehicle originally provided a more interior positioned pre-existing turn signal). Combining the movable latch portion with the pre-existing latch components further enhances the utility and aesthetics of the present invention.

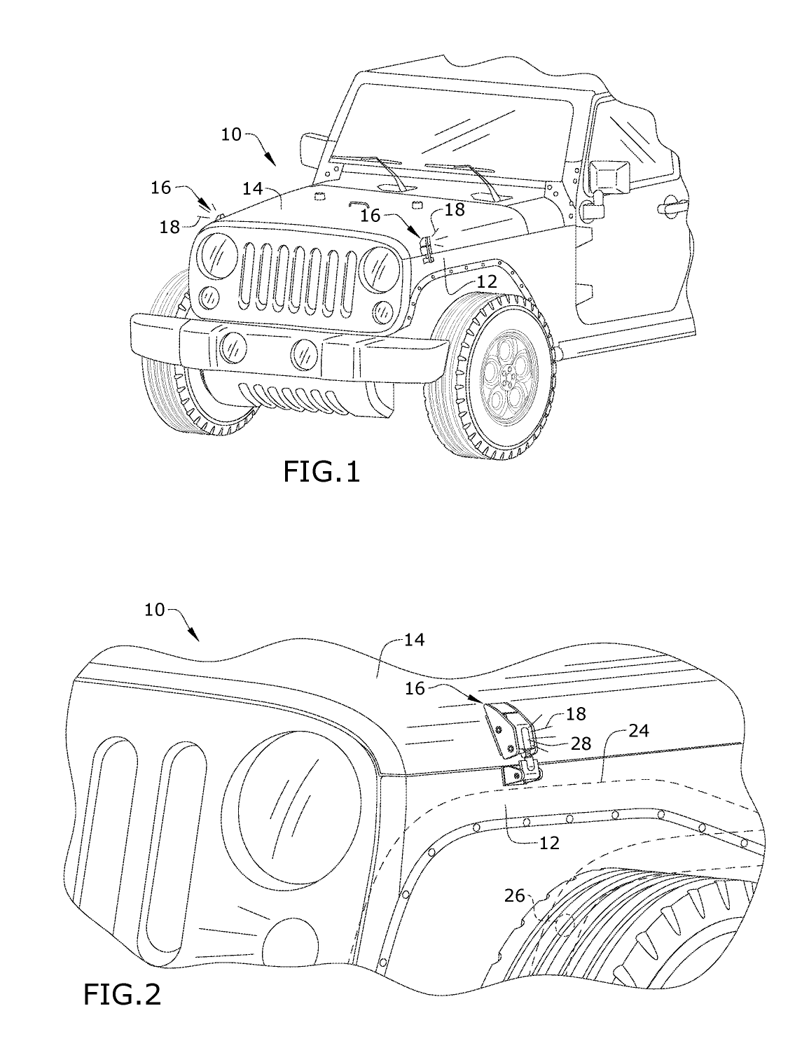

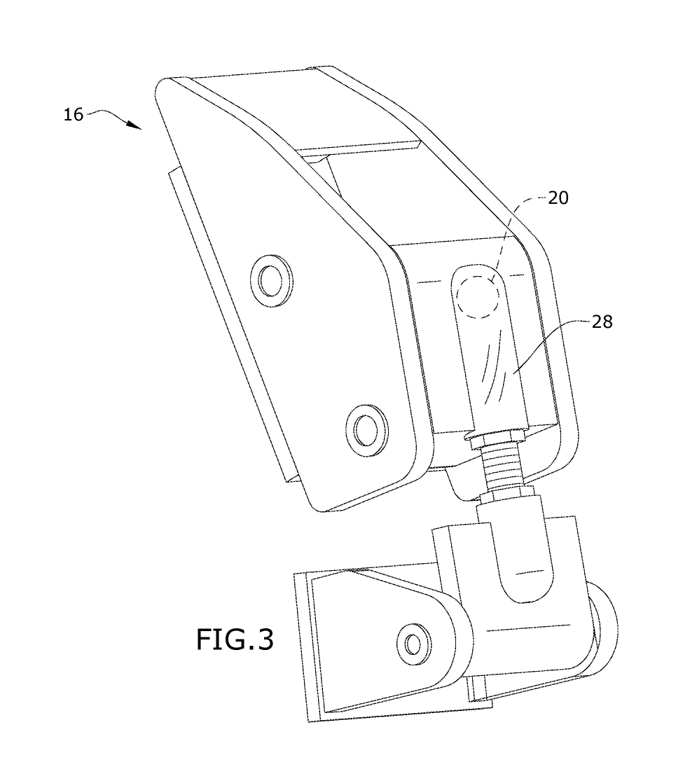

Referring now to FIGS. 1 through 5, the present invention may include a latching mechanism 16 adapted to interconnect a hood 14 and a body 12 of a vehicle 10 so that the latching mechanism 16 is moveable between an open condition and a closed condition securing the hood 14 to the body 12.

Referring to FIG. 5, the latching mechanism 16 may provide or may operatively associate with a pre-existing a hood portion 34 and a body portion 32 adapted to engage the hood 14 and body 12, respectively, in both the open and closed conditions. The latching mechanism 16 may provide a movable portion 36 adapted to pivot relative to the hood or body portion 34 or 32 when moving between the open and closed conditions, and secures to the opposing body or portion 32 or 34 in the closed condition.

The movable portion 36 may include an output device 20 in a casing 28. The output device 20 may be adapted to emit visual output 18. The visual output 18 may include but not be limited to light; accordingly, the output device 20 may include but not be limited to a light source, such as an LED device.

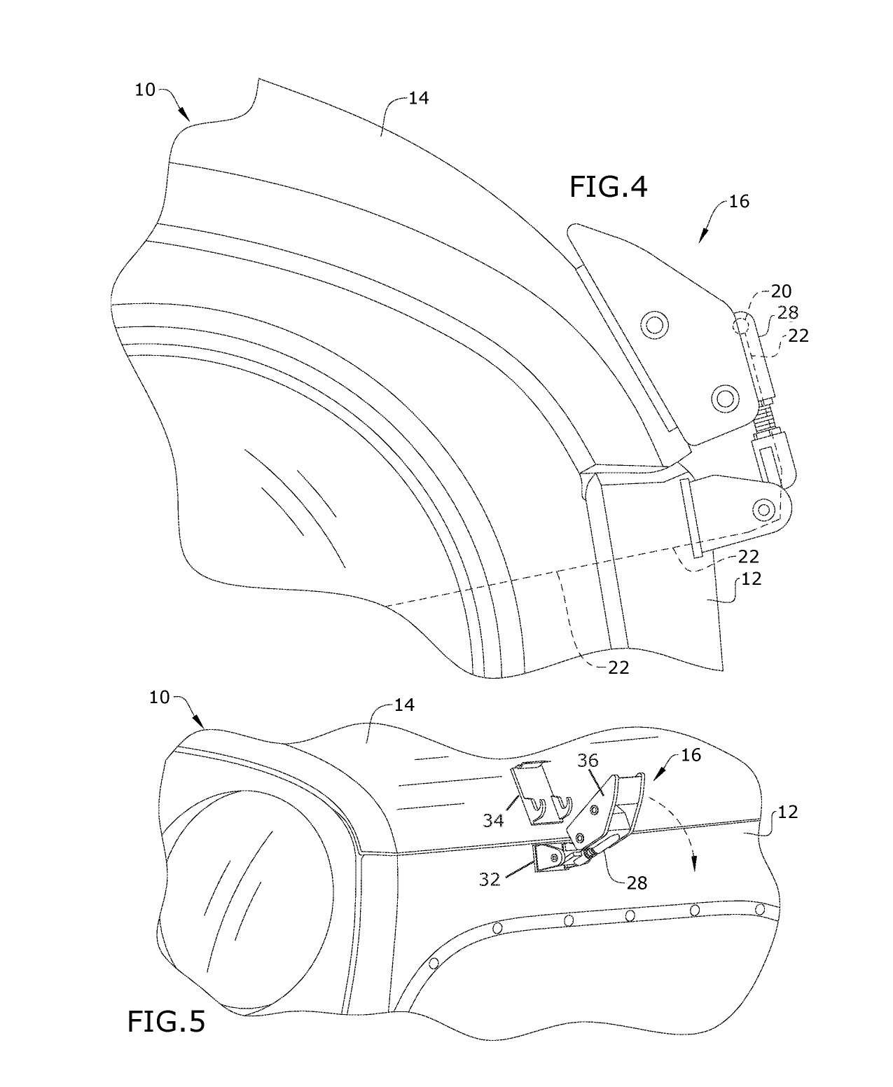

Referring to FIGS. 2 and 4, the output device 20 may retroactively be electrically connected to existing turn signal components 26 associated with an adjacent signal portion 24 of the vehicle 10, such as the fender. Such electrical connection may be wireless or include wiring 22. When using wiring 22, grommets of inductive material may be placed in the holes that the wiring 22 runs through when electrically connecting (e.g., via wire splice components) to said existing turn signal components 26, for example, by running the wiring 22 under the latch mechanism 16. In this example, since the wiring 22 may be spliced into the existing harness the output device 20 is enabled to get power anytime turn signal of the existing signal portion 24 is illuminated. Inside the casing 28 the visual output 18 (e.g., illumination) happens when the output device 20 gets power from the existing turn signal system, making them electrically and operatively associated. The grommets may keep the wiring 22 from grounding through the insulation when passing through the metal on the outside of the hood 14. The latching mechanism 16 or portions thereof may simply replace the existing hood latches that are present on a retrofitted vehicle 10.

A method of using the present invention may include the following. The latching mechanism 16 disclosed above may be provided. After operatively associating the latching mechanism 16 with a vehicle 10, such as a Jeep™, a user may replace the adjacent signal portion 24 of the vehicle 10 with an aftermarket adjacent signal portion 24—for example a stock fender with aftermarket fenders. During this process, the existing turn signal components 26 may be removed from the adjacent signal portion 24 (fender). This may make the vehicle 10 that is noncompliant with DOT requirements in some states, DOT compliant. Furthermore, giving the transparent casing 28 a dark tint may make the visual output 18 more aesthetically pleasing.

It should be understood, of course, that the foregoing relates to exemplary embodiments of the invention and that modifications may be made without departing from the spirit and scope of the present invention.

What is claimed is:

1. A method of providing turn signal functionality spaced apart from a vehicle, comprising the steps of:
providing a vehicle with a body and an adjacent hood;
pivotably connecting a movable latch portion to the body so that the movable portion moves between an open condition and a closed condition locking the hood to the body;
the movable portion providing a turn signal output device; and
electrically connecting the turn signal output device to turn signal control circuitry of the vehicle.

2. The method of claim 1, further comprising the steps of:
previously connecting a hood latch portion to the hood;
previously connecting a body latch portion to the body; and
the movable latch portion is pivotably connected to the body latch portion.

3. The method of claim 1, wherein the hood provides a pre-existing hood latch portion connected to the hood, and wherein the body provides a pre-existing body latch portion connected to the body; and
the movable latch portion is pivotably connected to the body latch portion.

4. The method of claim 1, wherein the turn signal output device is encased in a case.

5. The method of claim 1, wherein the turn signal output device spaced apart sufficiently in the closed condition to meet requirements of relevant state vehicular laws and rules regarding the location of turn signals.

6. A method of providing turn signal functionality spaced apart from a vehicle, comprising the steps of:
providing a vehicle with a body and an adjacent hood;
pivotably connecting a movable latch portion to the hood so that the movable portion moves between an open condition and a closed condition locking the hood to the body;
the movable portion providing a turn signal output device; and
electrically connecting the turn signal output device to turn signal control circuitry of the vehicle.

7. The method of claim 6, further comprising the steps of:
previously connecting a hood latch portion to the hood;
previously connecting a body latch portion to the body; and
the movable latch portion is pivotably connected to the hood latch portion.

8. The method of claim 7, wherein the hood provides a pre-existing hood latch portion connected to the hood, and wherein the body provides a pre-existing body latch portion connected to the body; and
the movable latch portion is pivotably connected to the hood latch portion.

9. The method of claim 8, wherein the turn signal output device is encased in a case.

10. The method of claim 9, wherein the turn signal output device spaced apart sufficiently in the closed condition to meet requirements of relevant state vehicular laws and rules regarding the location of turn signals.
